(19) United States
(12) Patent Application Publication
(10) Pub. No.: US 2022/0152435 A1
(43) Pub. Date: May 19, 2022

(54) AVALANCHE AIRBAG SYSTEM

(71) Applicant: ADVENATE GmbH, St. Johann (DE)

(72) Inventor: Andreas REITER, Grafing (DE)

(73) Assignee: ADVENATE GmbH, St. Johann (DE)

(21) Appl. No.: 17/603,383

(22) PCT Filed: Mar. 31, 2020
(86) PCT No.: PCT/EP2020/059157

§ 371 Date: Oct. 13, 2021

(30) Foreign Application Priority Data
Apr. 18, 2019 (DE) 10 2019 110 303.7

(51) Int. Cl. A62B 33/00; F04D 19/00; F04D 17/08; F04D 29/32; F04D 29/28; A63B 29/02

(52) U.S. Cl. CPC A62B 33/00; F04D 19/002; A63B 29/02; F04D 29/325; F04D 29/281; F04D 17/08

(57) ABSTRACT

An avalanche airbag system with an inflatable airbag and a filling unit for filling the airbag with a fluid has at least one pressure vessel containing a fluid, and a trigger mechanism for opening the at least one pressure vessel as required.

The invention relates to an avalanche airbag system with an inflatable airbag, a filling unit for filling the airbag with a fluid, comprising at least one pressure vessel containing a fluid, and a trigger mechanism for opening the at least one pressure vessel as required.

In snow-covered terrain an avalanche is understood as a mass of snow sliding down. Most of the avalanches that bury a person are triggered by the person who becomes buried. In the European Alpine region alone, on average 109 people die each year from the consequences of an avalanche.

Burial prevention systems (avalanche airbag systems) try to prevent the burial. The functional principle is based on a separation process. The relatively smaller parts of the mass move downwards, with the larger, more voluminous parts moving upwards. This sorting principle is called inverse segregation. According to this principle, the volume of a person is increased with the aid of an airbag in such a way that the person is prevented from sinking under the snow cover. In the idle state, the airbag is stowed in a compressed and/or folded form in closure pockets. The airbag is inflated by pulling a trigger handle fitted in the chest area. Previous systems inflate the buoyant body (airbag) either with high-pressure cartridges or an electric or battery-operated ventilator. The known systems using high-pressure cartridges are relatively heavy. The systems using a ventilator require an energy source. There are thus disadvantages associated with both systems.

The object of the present invention is to provide an avalanche airbag system which avoids the disadvantages mentioned above.

This object is achieved according to the invention by an avalanche airbag system having
a) at least one inflatable airbag,
b) a filling unit for filling the airbag with a fluid, comprising
   i. at least one pressure vessel containing a fluid,
   ii a trigger mechanism for releasing the fluid contained in the at least one pressure vessel as required, wherein
c) the filling unit has a housing which
   i. has a fluid outlet which is fluidically connected to the airbag,
   ii. and a fan impeller which is arranged in the housing and can be driven at least indirectly by the fluid flowing out of the at least one pressure vessel.

The avalanche airbag system according to the invention thus represents a hybrid form of the known systems. The pressure vessels can contain CO2 as a fluid. A commercially available CO2 cartridge can thus be used as the energy store that is used to inflate the airbag. It should be noted, however, that such a CO2 cartridge is not used directly to fill the airbag, but that the fan impeller is driven directly or indirectly by the gas escaping under pressure. Similar to a turbocharger, the fan impeller generates a flow of air that is used to fill the airbag. The connection of a pressure vessel and a fan impeller makes it possible to combine advantages of both known systems and to almost completely eliminate the disadvantages.

Both in comparison to the system which exclusively uses high-pressure cartridges to inflate the airbag, and to the known system which uses a fan that is electrically driven, there are significant weight advantages. A significantly smaller amount of gas is sufficient to fill the airbag, which results in a considerable reduction in weight. The pressure vessels of current systems are mostly expensive custom-made products. In contrast to this, with a system according to the invention it is possible to use commercially available gas cartridges as pressure vessels. Thus, a clear cost advantage can be realized. Furthermore, these commercially available pressure vessels are available worldwide and can be easily disposed of.

Compared to existing systems that use a ventilator, due to the lack of an energy source (rechargeable battery or battery) and capacitors, considerable volume savings with halved space requirements are possible. Since avalanche airbag systems are often arranged in a backpack, this means that a user has more space to accommodate items of equipment. Another advantage over battery-operated systems is the lack of sensitivity to cold. Overall, there are considerable improvements compared to not only systems with high-pressure cartridges but also battery systems.

The at least one pressure vessel can be opened by actuating the trigger system. Alternatively, the pressure vessel can be opened as soon as it is fixed, and this can be done by screwing it in, for example. By actuation of the trigger system, the pressurized trigger unit will release the fluid from the pressure vessel.

One or more pressure vessels can be provided. If several pressure vessels are provided, they can be activated by the trigger system simultaneously or one after the other and thus opened. It is conceivable to provide containers of different sizes. In principle, it is also conceivable to provide more than one fan impeller. It is conceivable to provide several fan impellers in one housing. As an alternative or in addition, several filling units, i.e. several housings, each with an associated fan impeller, can be provided. This results in redundancy which improves safety. One or more pressure vessels can be assigned to each fan impeller.

At least one nozzle can be arranged between the at least one pressure vessel and the fan impeller. The nozzle can be arranged in front of the housing or in the housing. In particular, the at least one nozzle can be integrated into the housing. If multiple nozzles are provided, they can be arranged at staggered positions. The gas flow escaping from the pressure vessel can be directed through the nozzles onto the fan impeller or a drive wheel to be described later. The gas escaping from the at least one pressure vessel can be used exclusively to drive the fan impeller. However, it is also conceivable that the escaping gas not only drives the fan impeller, but is also at least partially used to fill the airbag. The fan impeller itself, driven by the gas flow, generates a volume of air by which the airbag is inflated.

With the device according to the invention, there is no increase in the volume of gas which is present in the pressure vessels. The main task of the pressure vessel is to serve as an energy store, which drives the fan impeller via the stored gas pressure. The volume of gas that fills the airbag is generated by the fan impeller. The fluid used can be a gas, but this does not necessarily have to be present in compressed form as a gas in the pressure vessel, but can also be present in liquid form in the pressure vessel.

The airbag can be designed as an air-impermeable cover, for example as a fabric sack or synthetic fabric.

The at least one airbag is based on the current standard in terms of size, material and other design features. For example, it can have a volume of more than 150 liters.

The housing can have at least two parts. This facilitates the assembly of the fan impeller in the housing. The housing parts can be fitted together.

The fan impeller can be designed as an axial fan impeller or as a radial fan impeller.

The housing can form a spiral-like cavity.

In particular, if the fan impeller is designed as a radial fan impeller, it is advantageous if it is arranged in the spiral cavity. Half of the spiral cavity can be formed in each case by one housing half.

The cross section of the cavity can be constant. It is particularly preferred, however, if the cross section of the cavity increases toward the fluid outlet. By constructing the cavity as a spiral shape and with an increasing cross section, an increase in pressure can be achieved.

According to one embodiment of the invention, the fan impeller can be driven directly by the fluid flowing out of the pressure vessel. The pressure vessel or the nozzle can accordingly be arranged in such a way that the fluid escaping from the pressure vessel flows directly onto the fan impeller and is thus driven. In particular, the fluid can flow against the vanes of the fan impeller in order to set the fan impeller in motion. Alternatively, a drive wheel can be provided which is connected to the fan impeller and against which the fluid of the at least one pressure vessel can flow. Thus, a drive wheel is initially driven by the fluid escaping from the pressure vessel. In particular, the fluid flows appropriately against the blades of a drive wheel.

For this purpose, the drive wheel can be arranged in a drive wheel housing. The drive wheel housing can be a separate housing or it can be a component of the housing of the fan impeller.

The drive wheel can be coupled to the fan impeller directly via an axle, that is to say in particular non-rotatably. Alternatively, the drive wheel can be coupled to the fan impeller via a transmission gear.

In order to prevent fluid, in particular gas, from escaping from the airbag, a non-return device can be arranged in the region of the fluid outlet. In particular, a flap or a non-return valve can be provided.

The trigger system can comprise a trigger unit. In particular, the pressure vessel(s) can be fastened to the trigger unit. The trigger unit can have the task of holding the pressure vessel in position, sealing it off and, when a trigger handle which can be part of the trigger system is pulled, opening the vessel and letting the fluid escape from the pressure vessel. The trigger handle can be connected to a Bowden cable, for example. It is also conceivable to transmit a signal to the trigger unit by actuating a trigger handle. For example, electrical pulses which control a solenoid valve could be transmitted, and the pressure vessel could be opened as a result. Mechanical and electrical triggering or activation or opening of the pressure vessel is therefore conceivable. One or more trigger systems can be provided. If several trigger systems are provided, they can act simultaneously or one after the other when activated once by the user.

The trigger unit can be integrated into the housing. Thus, the trigger unit is arranged in a protected manner.

Further features and advantages of the invention are apparent from the following detailed descriptions of an embodiment of the invention with reference to the figures of the drawings, which show details essential to the invention, and from the claims. The features shown there are not necessarily to be understood as crucial and are shown in such a way that the special features according to the invention can be made clearly visible. The various features can each be implemented individually for themselves or for a plurality of combinations of any kind in variants of the invention.

The schematic drawings show embodiments of the invention at different stages of use and the subsequent description explains them in more detail.

In the drawings:

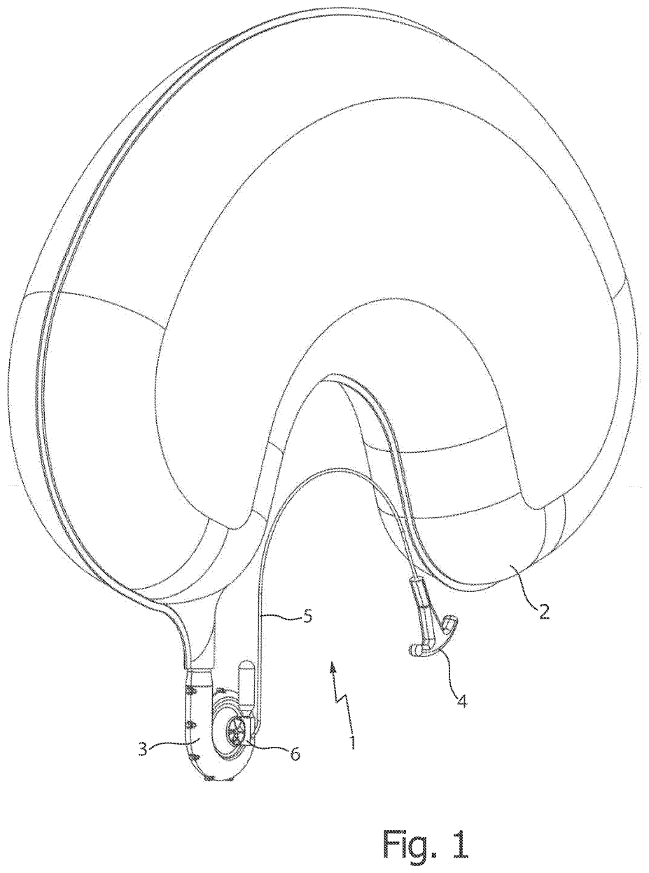

FIG. 1 is a first illustration of an avalanche airbag system with an inflated airbag;

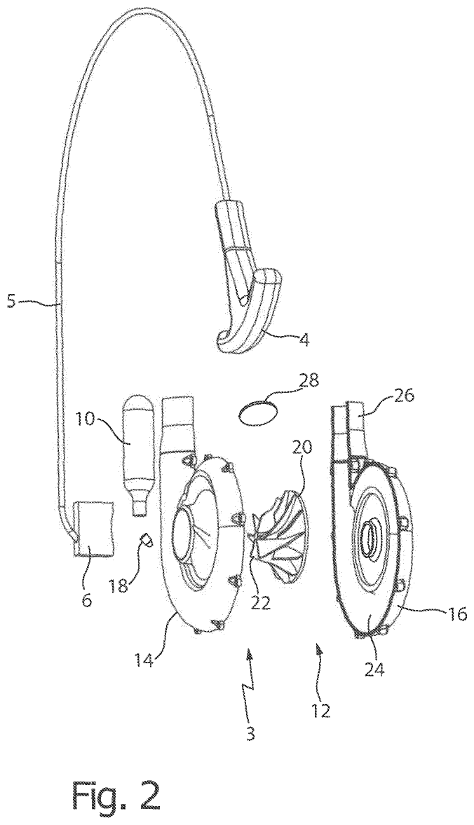

FIG. 2 is an exploded illustration of the filling unit of the avalanche airbag system;

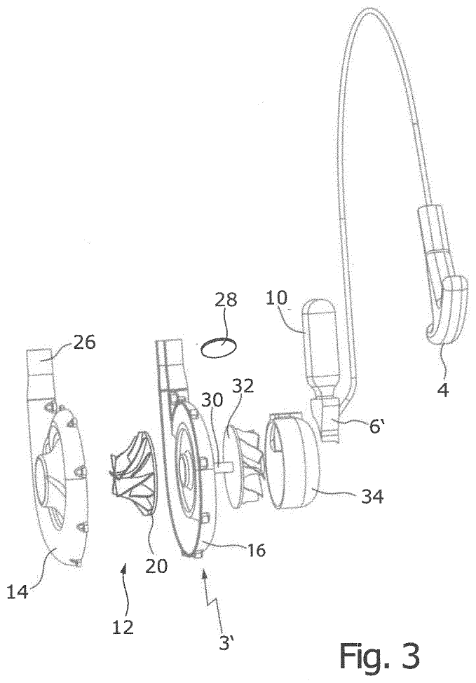

FIG. 3 is an exploded illustration of an alternative embodiment of a filling unit;

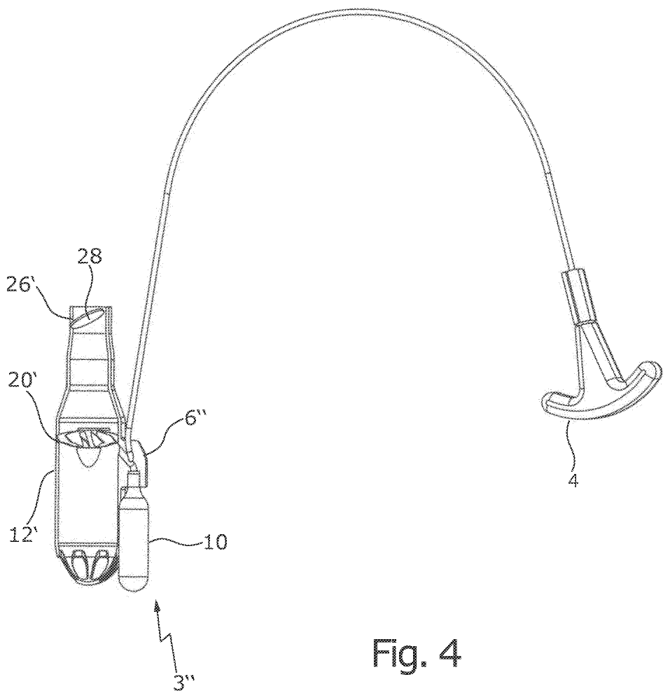

FIG. 4 shows a third embodiment of a filling unit of an avalanche airbag system.

FIG. 1 shows an avalanche airbag system 1 with an airbag 2 and a filling unit 3. In the non-activated, i.e. unfilled, state, the airbag 2 can be arranged in a backpack. The filling unit 3 can be arranged in or on the backpack. A trigger handle 4 is part of a trigger mechanism and can be easily accessible for a user on the backpack or, for example, on a carrying strap of the backpack, so that a user can trigger the avalanche airbag system 1 quickly and reliably if he is caught in an avalanche. The trigger handle 4 is connected to a filling unit 6 via a Bowden cable 5.

The airbag 2 is made of a gas-impermeable material. It can have a volume of at least 150 liters. If several airbags are provided, they can together have a volume of at least 150 liters.

FIG. 2 shows an exploded illustration of the filling unit 3. As described in connection with FIG. 1, a trigger handle 4 is connected to a trigger unit 6 via a Bowden cable 5. A pressure vessel 10, in which a fluid is in a liquid or gaseous state, is arranged on the trigger unit 6. By pulling the trigger handle 4, a user can actuate the trigger unit 6 so that the pressure vessel 10 is opened and pressurized gas can escape from the pressure vessel 10.

A nozzle 18 is arranged between the pressure vessel 10 and a housing 12, which has the housing halves 14, 16. The optional nozzle 18 is arranged and oriented in such a way that the gas escaping from the pressure vessel 10 is directed onto the fan impeller 20, in particular onto the vanes 22 of the fan impeller 20. The nozzle 18 can be designed as an outlet opening which is integrated into the housing 12. As a result of this measure, the fan impeller 20 is set in rotary motion. The fan impeller 20 is arranged rotatably in the housing 12. The fan impeller 20 is designed as a radial fan impeller. By rotation of the fan impeller 20, an air flow is generated in the housing 12. For this purpose, the housing 12 has a spiral cavity 24. In particular, the cavity 24 is formed by the housing halves 14, 16. The cross section of the spiral cavity 24 widens toward a fluid outlet 26 to which the airbag 2 is connected. A non-return device 28, which is designed as a non-return valve in the exemplary embodiment shown, is arranged in the region of the fluid outlet 26. This prevents gas from flowing back out of the airbag.

FIG. 3 shows an alternative embodiment of a filling unit 3′. Elements which correspond to those of FIG. 1 or 2 are identified by the same reference numerals. In this case too, a fan impeller 20 is rotatably arranged in the housing 12 with the housing halves 14, 16. The fan impeller 20 is non-rotatably connected to a drive wheel 32 via an axle 30. The drive wheel 32 is arranged in a housing 34, wherein the housing 34 virtually represents a second chamber of the housing 12. The trigger unit 6′ has a somewhat different shape than the trigger unit 6, but is otherwise designed like the trigger unit 6. The trigger unit 6′ is also connected to a pressure vessel 10 which can be activated or opened by the trigger unit 6′ when a user pulls the trigger handle 4. If the pressure vessel 10 is opened, the gas flowing out reaches the drive wheel 32, which is thereby driven. Due to the rigid coupling via the axle 30, the drive wheel 32 entrains the fan impeller 20 so that it generates an air flow by which the airbag 2 is inflated.

Another alternative embodiment 3″ is shown in FIG. 4. A pressure vessel 10 is connected to the trigger unit 6. By pulling the trigger handle 4, a user can open the pressure vessel 10 via the trigger unit 6″, so that gas flows out of the pressure vessel 10 into the housing 12 and there it drives a fan impeller 20′ which is rotatably arranged in the housing 12′. In this case, however, the fan impeller 20′ is not designed as a radial fan impeller, but as an axial fan impeller. The fan impeller 20′ is also driven by the gas flow from the pressure vessel 10 and thereby generates an air flow in the axial direction of the housing 12′ to the fluid outlet 26′, in which a non-return device 28 is arranged. It can be seen that the housing 12′ tapers toward the fluid outlet 26′. As a result, the pressure can be increased and the airbag can be inflated more reliably.

1. An avalanche airbag system (1) with
a. at least one inflatable airbag (2),
b. a filling unit (3, 3′, 3″) for filling the airbag (2) with a fluid, comprising
i. at least one pressure vessel (10) containing a fluid,
ii. a trigger mechanism for releasing the fluid (10) contained in the at least one pressure vessel as required,
wherein
c. the filling unit (3, 3′, 3″) has a housing (12, 12′) which
i. has a fluid outlet (26, 26′) which is fluidically connected to the airbag (2),
ii. and a fan impeller (20, 20′) which is arranged in the housing (12, 12′) and is configured to be driven at least indirectly by the fluid flowing out of the at least one pressure vessel (10).

2. The avalanche airbag system according to claim 1, wherein at least one nozzle (18) is arranged between the at least one pressure vessel (10) and the fan impeller (20, 20′).

3. The avalanche airbag according to claim 2, wherein the at least one nozzle (18) is integrated into the housing (12, 12′).

4. The avalanche airbag according to claim 1, wherein the housing (12, 12′) has at least two parts (14, 16).

5. The avalanche airbag system according to claim 1, wherein the fan impeller (20′) is designed as an axial fan impeller.

6. The avalanche airbag system according to claim 1, wherein the fan impeller (20) is designed as a radial fan impeller.

7. The avalanche airbag system according to claim 1, wherein the housing (12) forms a spiral cavity.

8. The avalanche airbag system according to claim 7, wherein the cross section of the cavity (24) increases toward the fluid outlet (26).

9. The avalanche airbag system according to claim 1, wherein the fan impeller (20, 20′) is configured to be driven directly by the fluid flowing out of the pressure vessel (10).

10. The avalanche airbag system according to claim 1, further comprising a drive wheel (32) is connected to the fan impeller (20) and against which the fluid of the at least one pressure vessel (10) can flow.

11. The avalanche airbag system according to claim 10, wherein the drive wheel (32) is arranged in a drive wheel housing (34).

12. The avalanche airbag system according to claim 10, wherein the drive wheel (32) is coupled to the fan impeller (20) directly via an axle (30) or via a transmission gear.

13. The avalanche airbag system according to claim 1, wherein a non-return device (28) is arranged in a region of the fluid outlet (26, 26′).

14. The avalanche airbag system according to claim 1, wherein the trigger mechanism comprises a trigger unit (6, 6′, 6″).

15. The avalanche airbag system according to claim 14, wherein the trigger unit (6, 6′, 6″) is integrated into the housing (12, 12′).
